(19) United States
(12) Patent Application Publication
(10) Pub. No.: US 2024/0206480 A1
(43) Pub. Date: Jun. 27, 2024

(54) FOOD PRODUCT

(71) Applicant: Mars, Incorporated, McLean, VA (US)

(72) Inventors: Laura MUNOZ, Chicago, IL (US); Jiska MAARSEN, Eersel (NL)

(73) Assignee: Mars, Incorporated, McLean, VA (US)

(21) Appl. No.: 18/557,678

(22) PCT Filed: Apr. 29, 2022
(86) PCT No.: PCT/US2022/027081

§ 371 Date: Oct. 27, 2023

(30) Foreign Application Priority Data
Apr. 30, 2021 (GB) 2106249.2

(51) Int. Cl. A21D 13/02; A21D 13/17; A23G 1/54; A23G 3/42; A23L 33/21

(52) U.S. Cl. CPC A21D 13/02; A21D 13/17; A23G 1/54; A23G 3/42; A23L 33/21

(57) ABSTRACT

A food product is described. The food product comprises a biscuit component, wherein the biscuit component comprises a grain inclusion; a honey caramel component, wherein the caramel component comprises from 1 to 60 wt % soluble fiber; and a chocolate component comprising from 1-30 wt % soluble fiber. Also described is a method of making the food product.

### FIELD OF THE INVENTION

The present invention relates to a food product, which may be termed a confection. A method for making the food product is also provided.

### BACKGROUND OF THE INVENTION

Confectionery products such as chocolate are popular food products. The traditional ingredients for chocolate are derived from the cocoa bean. Products labelled “milk chocolate” usually contain milk and added sugars. Products labelled “dark chocolate” may also contain milk and sugar in lower quantities. Many chocolate products also contain additional elements, such as caramels, nougats or biscuit, all of which also contain sugars.

Caramel is another popular confectionery product. Caramels, toffees and fudges are particularly popular confectionery items. They may be available as a discrete product in itself. Alternatively, they may be present as a component of composite confectionery items such as bars which comprise other elements such as chocolate, as well as nougats, nuts, wafers, biscuits, gels, flavoured creams or praline. Caramels are characterised as high sugar containing confections. A substantial proportion of the sugar may be provided by glucose syrup or sucrose, but caramels typically also contain fats, milk, flavourings and water.

The amount of water present in any particular caramel, toffee or fudge, will impact on its taste and texture, but also, of its processability. And, while some caramel, toffee or fudge confections are desirably more fluid, e.g., ice cream toppings or certain filled confections, in other applications, these confections may desirably be chewy in texture. Such confectionery items will contain less water. While the former can be messy to consume, but easy to deposit, the latter provides a cleaner consuming experience, but can be difficult to handle during manufacture.

Confectionery products containing high levels of refined or added sugars can be problematic for those suffering from diabetes, or those who are obese or overweight and are attempting to lose weight. There is therefore an increasing need to provide a low calorie confection that possesses the taste, texture and feel of a standard chocolate confection, is economical to produce, and has favourable processability and rheological properties. These type of confections provide particular challenges as such products can be difficult to manufacture. There is a need for further food products.

The following disclosure is presented to provide an illustration of the general principles of the present invention and is not meant to limit, in any way, the inventive concepts contained herein. Moreover, the features described in this section can be used in combination with the other described features in each of the multitude of possible permutations and combinations contained herein.

### SUMMARY OF THE INVENTION

The invention provides a food product comprising:
a biscuit component, wherein the biscuit component comprises a grain inclusion;
a honey caramel component, wherein the caramel component comprises from 1 to 50 wt % soluble fiber; and
a chocolate component, wherein the chocolate component comprises from 1-30 wt % soluble fiber.

It has been found that a food product according to the invention scores well in consumer taste tests and thus provides an acceptable alternative to existing food products containing high calorie and/or high glycaemic index ingredients.

### DETAILED DESCRIPTION OF THE PREFERRED EMBODIMENTS

The present specification provides certain definitions and methods to better define the present invention and to guide a person skilled in the art in the practice of the present invention. Provision, or lack of the provision, of a definition for a particular term or phrase is not meant to imply any particular importance, or lack thereof. Rather, and unless otherwise noted, terms are to be understood according to conventional usage by those persons skilled in the relevant art. Additional features and advantages of the present invention are described in, and will be apparent from, the description of the presently preferred embodiments which follow below.

As used herein, the terms “low sugar”, “added sugar”, “simple sugar” and “refined sugar” refer to processed sugars products, as would be obtained from the processing of sugar beet and sugar cane to obtain, for example the pure monosaccharides glucose and fructose, or the disaccharide sucrose. Refined sugars such as sucrose, glucose and fructose are high glycaemic carbohydrates, and are thus undesirable in products for those seeking to manage their weight. The terms are not intended to encompass naturally occurring sugar products such as honey, nor any polysaccharide or oligosaccharide containing glucose or fructose, nor any lactose (a disaccharide) that may be naturally present in any milk or dairy product that may be used in the preparation of the food product.

As used herein, the terms “dietary fiber”, “soluble dietary fiber”, “soluble fiber” or “water soluble (dietary) fiber” are to naturally occurring materials such as inulin, a fructan based on polyfructose, and shorter oligofructosaccharides, that are water soluble, or at least swell in water. Other soluble dietary fibers that may be used in any component of the present food product include dextrins, which are low molecular weight polyglucose molecules produced by the hydrolysis of starch or glycogen. These materials have a low calorific content (approximately 1 cal/g), and so are desirable substitutes for refined sugars, in particular as bulk sugar replacers typically used in confectionery.

Other sources of water soluble dietary fiber include but are not limited to beta glucan, carrageneen, guar, gum acacia, xanthan gum, and pectin, and combinations thereof. A further example of soluble dietary fibers includes soluble corn fiber (SCF), an example of such an SCF is PROMITOR® Soluble Fibre 70 or PROMITOR® Soluble Fibre 85 (supplied by Tate & Lyle).

As used herein, a “low sugar” milk chocolate is a milk chocolate having less than 50 wt % or less than 30 wt % or less than 25 wt % of an added/refined sugar selected from sucrose, glucose and fructose.

As used herein, references to “weight percent” or “wt %” are to the amount of a particular component in a composition, based on the total weight of that composition. For example, references to “wt %” of a soluble fiber in a honey caramel component are to the amount (by weight) of the soluble fiber in the honey caramel component, and not to the total amount (by weight) of the soluble fiber in a food product including the honey caramel component, unless otherwise stated.

### Food Product

There is described herein a food product comprising:
a biscuit component, wherein the biscuit component comprises a grain inclusion;
a honey caramel component, wherein the caramel component comprises from 1 to 60 wt % soluble fiber; and
a chocolate component, wherein the chocolate component comprises from 1-30 wt % soluble fiber.

Herein is provided a food product comprising
a biscuit component as described herein;
a honey component as described herein; and
a chocolate component as described herein.

The food product may comprise, consist essentially of or consist of:
the biscuit component described herein; and
the honey caramel component as described herein; and
the chocolate as described herein.

It has unexpectedly been discovered that a low-calorie food product of caramel and biscuit enrobed in chocolate, having reduced levels of high calorie sugar, and a lower glycaemic index can be prepared without sacrificing any of the sensory experience with regard to at least flavours and textures.

The food product may be in the form of a bar comprising a layer of the biscuit component and a layer of the honey caramel component. The honey caramel may partly or completely cover the biscuit. The biscuit may form a layer and the honey caramel may cover one or more sides of, optionally all sides of, the layer of biscuit. The honey caramel may partly or completely cover the biscuit. The biscuit layer and the caramel layer may be enrobed in the chocolate component. The food product may also be in the form of small bite size pieces.

The food product may further comprise a barrier cream between the biscuit component and the honey caramel component. Barrier creams, such as barrier fats, are used in the confectionery industry as thin films between different layers of a food product, to prevent moisture from one component migrating to a drier component. The barrier cream may therefore be used to prevent moisture migration from the honey caramel component to the biscuit component. In some examples, the barrier cream may comprise less than 20 wt %, for example less than 10 wt % of the food product, for example less than 7 wt % or 8 wt % of the food product.

The food product may be in the form of a bar. The food product may be in the form of a elongate bar, such as a finger.

The food product may comprise 1-60 wt %, for example 10-50 wt %, or 25-40 wt % of the biscuit component; 1-60 wt %, for example 10-50 wt %, or 25-40 wt % of the honey caramel component; and 1-60 wt %, for example 10-50 wt %, or 25-40 wt % of the chocolate component, and optionally comprising 2-20 wt %, for example 2-10 wt % of a barrier cream.

In some examples, the food product comprises less than 40% wt % sugar, for example less than 30 wt % sugar content or less than 25 wt % sugar content, by which it will be understood that this refers to the content of refined sugars and/or naturally occurring sugars such as honey, and not to the naturally occurring polysaccharides or oligosaccharides that may be present as soluble fiber.

### Biscuit Component

The food product comprises a biscuit component, wherein the biscuit component comprises a grain inclusion.

As used herein, the term “biscuit” refers to flour-based baked food product, which is typically hard and crunchy, evidence of a low moisture content, though a biscuit may also have a chewy texture. In some examples, the biscuit is formed from a whole grain flour, such as a whole wheat flour, or a whole barley flour, to reduce the glycaemic index of the biscuit. The biscuit component may also be formed from other ingredients typically used to make biscuits, for example sugar and water, and a fat such as sunflower oil, palm oil, butter, coconut oil.

The biscuit component includes a grain inclusion, which may be a whole grain. In one example, the grain inclusion in the biscuit component comprises one or more whole grains selected oats, rolled oats, wheat, barley and quinoa. Inclusion of whole grains reduces the glycaemic index and caloric content of a foodstuff. The grain inclusion may be present in the biscuit component in an amount of from 5-50 wt %, for example 10-40 wt %, for example 15-30 wt %. The biscuit component may be any desirable biscuit component that provides for a crunchy, or chewy texture of experience for the consumer.

The biscuit component may be formed by preparing a raw biscuit dough of flour, water, and optionally sugar and/or a fat (along with other desirable components such as flavourings and/or salt or bicarbonate), and mixing the grain inclusion into the raw dough. Thus, the biscuit component may be formed by mixing or folding a grain inclusion such as rolled oats into a raw biscuit dough.

The biscuit dough may comprise from 5 to 50 wt %, for example 10-40 wt %, for example 15-30 wt % of the grain inclusion. The biscuit dough may comprise flour, for example whole grain flour in an amount of from 5 to 60 wt %, for example 20-50 wt %, for example 30-40 wt % of the final biscuit. The biscuit dough may comprise sugar in an amount of from 10 to 25 wt % by weight of the final biscuit, preferably from 10 to 20 wt %; and/or fat in an amount of from 5 to 25 wt % by weight of the final biscuit, preferably from 10 to 20 w % of the final biscuit.

The biscuit component may be formed by preparing a raw biscuit dough containing a grain inclusion, and baking the raw biscuit dough in any desirable form. Typically, biscuits have a defined shape, and are formed by baking a raw biscuit dough in a mould at a temperature and for a time until the biscuit is baked and has a desired level of moisture content. The biscuit may have a water activity of less than 0.6, for example less than 0.4.

### Honey Caramel Component

The honey caramel component comprises 1-60 wt %, for example 10-50 wt %, for example 15-40 wt %, for example 20-30 wt % honey. Honey is a naturally occurring, non-refined sugar and is widely considered to have advantageous nutritional and health benefits over refined sugars. Any suitable honey may be included in the honey caramel component, and may be chosen based on a particular texture, viscosity or flavour attribute based on requirement. For example, it may be desirable to use a heather honey to impart its distinctive aroma and taste to the caramel. In some embodiments the honey caramel may comprise inclusions such as nuts, or nut paste or natural honey flavouring.

The honey caramel comprises from 1 to 60 wt % soluble fiber, for example 1 to 50 wt % soluble fiber, otherwise termed water-soluble dietary fiber. In some examples, the honey caramel comprises from 5 to 40 wt %, for example from 10 to 35 wt %, for example from 15 to 30 wt % soluble fiber. Inclusion of a soluble fiber enables the amount of refined sugar to be reduced while maintaining product quality and organoleptic properties. Water-soluble dietary fibers are suitable for individuals suffering from diabetes as they do not result in an increase in blood glucose levels. The honey caramel may be termed a high fiber honey caramel, by virtue of the content of soluble fiber. Introducing these levels of fiber into the caramel result in a nutritious food product with a desirable sensory experience, and can reduce the amount of refined sugars and conventional humectants required to maintain user satisfaction and product lifetime.

The honey caramel component may comprise soluble dietary fiber in the form of a soluble corn fiber such as PROMITOR® 85L, a prebiotic soluble corn fiber in liquid form with at least 85% dietary fiber, and less than 2% sugars. The honey caramel component may comprise a soluble dietary fiber in the form of a naturally occurring polysaccharides such as an inulin, a fructan, or an oligofructosaccharide. The honey caramel component may comprise a soluble dietary fiber derived from chicory root. Soluble dietary fibers, often called functional fibers are prebiotic materials that have been proven to be important for advantageously balancing intestinal flora, and supporting low-glycaemic diets. The soluble fiber in the honey caramel component can impart a creamy texture and sweet taste, meaning less fat and less refined sugar needs to be included in the caramel.

The honey caramel may comprise a sugar syrup, a milk product, and a fat.

The honey caramel may comprise a sugar syrup in addition to the honey. The sugar syrup may be selected from sucrose syrup, glucose syrup, invert syrup, and mixtures thereof. The sugar syrup may comprise water. The honey caramel component may comprise less than 50 wt %, for example less than 40 wt %, for example less than 30 wt %, for example less than 20 wt %, for example from 10 to 30 wt % sugar syrup, for example less than 10 wt %. The inclusion of soluble dietary fiber enables the use of lower amounts of refined sugars and sugar syrups. In some examples, the sugar syrup is glucose syrup.

In some examples, the honey caramel comprises less than 30 wt %, for example less than 25 wt % of an added or simple sugar, for example a refined sugar selected from pure sucrose, fructose or glucose, or a syrup thereof.

The milk may be present in the honey caramel in an amount of from 1 to 20 wt %, for example from 2 to 18 wt %, for example from about 3 to 8 wt %.

The milk may be selected from dairy milk, or a plant-based milk selected from coconut milk, almond milk, soy milk, rice milk, cashew milk, hemp milk, oat milk, flax milk, hazelnut milk, pea milk, and mixtures thereof. Preferably the milk is dairy milk, and may be a condensed milk. The milk may be a milk powder, for example a skimmed milk powder. The milk may be a skimmed milk powder present in the honey caramel in an amount of from 1 to 20 wt %, for example from 2 to wt %, for example from about 3 to 8 wt %.

The fat may be selected from dairy butter, peanut oil, milk fat, palm oil, cocoa butter, palm fat, olive oil and sunflower oil and mixtures thereof. It will be understood that the fat is in addition to fat present in the milk. The fat may be present in in the honey caramel in an amount of from 1 to 30 wt %, for example from 1 to 20 wt %, for example 5 to 20 wt %, preferably 3-18 wt %, most preferably 5-18 wt %.

In some examples, the honey caramel component comprises a caramel syrup, a milk and a fat. The milk and the fat may be as described above. Thus, in some examples, the honey caramel component comprises from 1-90 wt % caramel syrup, for example from 5-80 wt %, for example from 10-70 wt %; from 1-25 wt % milk, for example from 5-20 wt %, for example from 10-15 wt %; and from 1-40 wt % fat, for example from 5-30 wt %, for example from 10-20 wt %.

A caramel syrup may comprise a soluble fiber as described herein, the honey, and a sugar syrup. The caramel syrup may comprise from 1 to 90 wt % soluble fiber, for example 20 to 70 wt % soluble fiber, for example 30 to 60 wt % soluble fiber, otherwise termed water-soluble dietary fiber.

A caramel syrup may comprise a honey as described herein, in an amount of from 5 to 60 wt %, for example from 10 to 50 wt %, for example from 20 to 45 wt % honey.

A caramel syrup may comprise a sugar syrup as described herein, for example a sugar syrup selected from sucrose syrup, glucose syrup, invert syrup, and mixtures thereof. The sugar syrup may comprise water. The caramel syrup may comprise less than 30 wt %, for example less than 20 wt %, for example less than 10 wt % sugar syrup.

Thus, in some examples, a caramel syrup may comprise from 20 to 70 wt % soluble fiber, 20 to 45 wt % honey and less than 10 wt % sugar syrup.

The honey caramel may comprise one or more inclusions, such as nut inclusions. The nut inclusions may comprise whole or chopped nuts from any desirable nut, including but not limited to peanuts, almonds, cashew nuts, brazil nuts, hazelnuts, pistachio nuts, pecan nuts, walnuts and macadamia nuts, and combinations thereof. The nut inclusion may comprise chopped nuts of about 2-4 mm in size. When present, the nuts, for example the chopped nuts, may form for example 1-60 wt %, 1-50 wt %, preferably 5-40 wt %, most preferably 1-30 wt % of the honey caramel component.

The honey caramel may comprise a nut flavouring, such as a nut paste. The nut paste may comprise a paste formed from any desirable nut, including but not limited to peanuts, almonds, cashew nuts, brazil nuts, hazelnuts, pistachio nuts, pecan nuts, walnuts and macadamia nuts, and combinations thereof. When present, the nut paste may form for example 1-60wt %, 1-50 wt %, preferably 5-40 wt %, most preferably 1-30 wt % of the honey caramel component.

The honey caramel may further comprise a honey flavouring to enhance the honey notes of the honey caramel. When present, the honey flavouring may be used in an amount of less than 5 wt %, for example less than 3 wt %, for example less than 2 wt % of the honey caramel.

Thus, in some examples, the honey caramel component comprises from 1-95 wt % honey caramel, for example from 10-90 wt %, for example from 20-85 wt %; from 1-30 wt % nut inclusions or nut paste, for example from 2-20 wt %; and less than 2 wt % honey flavouring, for example about 1 wt %.

Advantageously, the honey caramel provides sensory properties that are equivalent to caramels with much higher refined sugar content.

The honey caramel may be made by a process comprising the steps of:
providing a batch milk comprising milk and a fat; and
adding a honey to the batch milk to form a caramel.

The method may include adding a sugar syrup along with the honey. The method may include adding a soluble fiber to the batch milk, at the same time as, or at a different time to, the addition of the honey. The honey, milk, fat, and sugar syrup are as described above in connection with the honey caramel.

The honey may be heated to 115-145° C., preferably 120-140° C., most preferably 125-135° C. The honey may form from 1-60 wt %, for example 10-50 wt %, for example 15-40 wt %, for example 20-30 wt % of the honey caramel, while the sugar syrup may form less than 50 wt %, for example less than 40 wt %, for example less than 30 wt %, for example less than 20 wt %, for example from 10 to 30 wt %, for example less than 10 wt % of the ingredients used to make the honey caramel. The soluble fiber and the sugar syrup, when used, may be added to the honey before heating, or may be heated separately to the same temperatures added to the batch milk separately.

The honey caramel may be made by a process comprising the steps of:
providing a batch milk comprising milk and a fat; and
adding a caramel syrup comprising soluble fiber, honey and sugar syrup to the batch milk to form a caramel.

The caramel syrup may be heated to 115-145° C., preferably 120-140 20 C., most preferably 125-135° C.

The soluble fiber may form from 1-90 wt %, for example 20-70 wt %, for example 30-60 wt % of the caramel syrup, while the honey may form from 5 to 60 wt %, for example from 10 to 50 wt %, for example from 20 to 45 wt % of the caramel syrup, and the sugar syrup may form less than 30 wt %, for example less than 20 wt %, for example less than 10 wt % of the ingredients used to make the caramel syrup. The soluble fiber, honey and the sugar syrup may be mixed together before heating, or may be heated separately to the same temperatures and then mixed before being added to the batch milk.

The batch milk may be heated before the honey or the caramel syrup is added, preferably to 30-80° C., most preferably to 40-70° C. The process may include a further step of heating the caramel to evaporate moisture and form a browned caramel, preferably at a temperature of 100-150° C., most preferably 120-145° C. Advantageously, the browned caramel has an improved flavour. The heating time and temperature can be adjusted depending on need, with longer times and higher temperatures leading to a darker browned caramel with a more intense flavour. The soluble fiber included in the honey caramel does not adversely affect the formation or qualities of the honey caramel and can in fact improve consumer experience while reducing sugar and calorie content.

The batch milk may comprise further ingredients selected from flavourings such as vanilla extract, salt, and mixtures thereof.

The milk may form 15-55 wt %, preferably 25-45, preferably 20-50 wt %, most preferably 30-40 wt % of the ingredients used to make the honey caramel. The fat may form 1-30 wt %, 1-20 wt %, preferably 3-18 wt %, most preferably 5-18 wt % of the ingredients used to make the honey caramel. It will be understood that these amounts do not include fat present in the other ingredients of the caramel, e.g. the milk.

The process for making honey caramel may include mixing the ingredients in a heating vessel; heating the ingredients to form a uniform heated mixture while scraping the vessel during heating to prevent scorching; and increasing the heat to boil the ingredients to a temperature and for a time to achieve a desired level of caramelisation.

### Barrier Cream

The food product may further comprise a barrier cream, for example between the biscuit component and the honey caramel component. In some examples, the barrier cream may comprise less than 20 wt %, for example less than 10 wt % of the food product, for example less than 7 wt % or 8 wt % of the food product.

In some examples, the barrier cream comprises substantially a sugar and fat, for example as described above in connection with the other components of the food product.

In some examples, the barrier cream comprises a ratio of sugar to fat of from 1:5 to 5:1, for example from 1:3 to 3:1, for example in an approximate 1:1 ratio of sugar to fat. In some examples, the barrier cream comprises one or more flavorants, such as a chocolate flavorant, or a vanilla flavorant, or combinations thereof.

### Chocolate Component

The food product comprises a chocolate component comprising 1-30 wt % soluble fiber. In some examples, the chocolate component comprises a low sugar milk chocolate comprising one or more dietary fiber selected from dextrin, inulin and a fructooligosaccharide. Soluble dietary fibers such as these have been found suitable for replacing refined sugars without any loss of sweetness, while simultaneously enhancing the creaminess of a food product.

The chocolate component may comprise one or more types of soluble dietary fiber as a major component of the chocolate component. The one or more types of soluble dietary fiber may be present in a greater amount than any added or refined sugar component. For examples, the chocolate component may comprise from 1-30 wt % of a soluble dietary fiber, for example from 10 to 30 wt %, for example from 20 to 30 wt %. It will be understood that the chocolate component may also include other ingredients required to make a milk chocolate, including, cocoa butter, cocoa liquor, milk, for example a milk powder, fats such as vegetable fats, and a flavoring such as vanilla.

### Process for Making Food Product

Herein is provided a method of producing a food product, the method comprising combining the biscuit component, the honey caramel component and the chocolate component to form the food product.

In an embodiment, the biscuit component is produced, preferably in the form of a layer of baked biscuit, and then one or more of the other components of the food product are coated onto the biscuit.

In an embodiment, the biscuit is produced, preferably in the form of a layer, and then the honey caramel is coated on one or more sides of the biscuit, and then the chocolate is coated onto the biscuit and honey caramel on at least one side, optionally all sides of the biscuit and caramel to completely envelope the biscuit and caramel in the chocolate. In order to ease processing, the biscuit and honey caramel may be in a chilled form during production, as this will enable the chocolate component in liquid form to more quickly solidify during enrobing.

### EXAMPLE

A biscuit was prepared from the following ingredients:
Fat 15 wt %
Water 10 wt %
Oat flakes 23 wt %
Wheat Flour 35 wt %
Sugar 15 wt %
Salt 2 wt %

### Total 100%

The biscuit was preparing by mixing the ingredients to form a raw dough including oat flakes, forming the dough into a finger in a mould, and baking the dough at 160° C. until cooked.

A low sugar honey caramel was prepared from the following ingredients:
Soluble corn fiber 28 wt %
Glucose syrup 20 wt %
Honey 22 wt %
Palm fat 15 wt %
Water 7 wt %
Skimmed milk powder 8 wt %

### Total 100%

The honey caramel was prepared by mixing the ingredients, and then heating to 140° C.

A commercially available barrier cream (Sugar: 48 wt %; Fat: 47% wt %; Cocoa powder: 4 wt %; Flavouring (vanilla): 1 wt %) was provided as a thin on a top surface of the biscuit before the honey caramel was then layered on top, and a commercially available low sugar milk chocolate applied so as to enrobe the biscuit/barrier cream/honey caramel, giving a product with 26 wt % biscuit with oats, 33 wt % reduced sugar honey caramel, 35 wt % reduced sugar chocolate and 6 wt % barrier cream. The product contained almost 6 wt % rolled oats, 7 wt %, and 7.3 g fiber per 46 g portion. A taste panel found the product to be an enjoyable confectionery product, notwithstanding that it was a low sugar, low calorie product.

It should be understood that various changes and modifications to the presently preferred embodiments described herein will be apparent to those skilled in the art. Such changes and modifications can be made without departing from the spirit and scope of the present invention and without diminishing its attendant advantages. It is therefore intended that such changes and modifications be covered by the appended claims.

1. A food product comprising:
a biscuit component, wherein the biscuit component comprises a grain inclusion;
a honey caramel component, wherein the honey caramel component comprises 1-60 wt % soluble fiber; and
a chocolate component, wherein the chocolate component comprises 1-30 wt % soluble fiber.

2. The food product according to claim 1, wherein the grain inclusion in the biscuit component comprises one or more whole grains selected oats, rolled oats, wheat, barley and quinoa.

3. The food product according to claim 1, wherein the honey caramel component comprises 10-60 wt %, for example 10-50 wt %, for example 15-40 wt %, for example 20-30 wt % honey.

4. The food product according to claim 1, wherein the grain inclusion is present in the biscuit component in an amount of 5-50 wt %, for example 10-40 wt %, for example 15-30 wt %.

5. The food product according to claim 1, wherein the honey caramel component comprises a soluble corn fiber or a soluble fructooligosaccharide.

6. The food product according to claim 1, wherein the honey caramel component comprises 1-50 wt %, for example 5 to 40 wt %, for example 10 to 35 wt %, for example 15-30 wt % soluble fiber.

7. The food product according to claim 1, wherein the caramel component comprises less than 50 wt %, for example 10-30wt %, or 10 wt % or less sugar syrup.

8. The food product according to claim 1, which is in the form of a bar comprising a layer of the biscuit component and a layer of the honey caramel component.

9. The food product according to claim 8, wherein the biscuit layer and the caramel layer are enrobed in the chocolate component.

10. The food product according to claim 1, further comprising a barrier cream between the biscuit component and the honey caramel component.

11. The food product according to claim 1, wherein the chocolate component comprises a low sugar milk chocolate, having less than 30 wt %, for example less than 25 wt % of an added sugar selected from sucrose, glucose and fructose.

12. The food product according to claim 1, wherein the chocolate component comprises a low sugar milk chocolate comprising one or more dietary fiber selected from dextrin, inulin and a fructooligosaccharide.

13. The food product according to claim 1, comprising:
1-60 wt %, for example 10-50 wt %, or 25-40 wt % of the biscuit component;
1-60 wt %, for example 10-50 wt %, or 25-40 wt % of the honey caramel component; and
1-60 wt %, for example 10-50 wt %, or 25-40 wt % of the chocolate component, and optionally comprising 2-20 wt %, for example 2-10 wt % barrier cream.

14. A method of producing a food product . the method comprising:
combining a biscuit component comprising a grain inclusion, a honey caramel component comprising 1-60 wt % soluble fiber, and a chocolate component comprising 1-30 wt % soluble fiber to form the food product.
